(19) United States
(12) Patent Application Publication
(10) Pub. No.: US 2025/0348898 A1
(43) Pub. Date: Nov. 13, 2025

(54) SYSTEM AND METHOD FOR PRICE OPTIMIZATION USING GRAPH-BASED MACHINE LEARNING

(71) Applicant: Tymestack Pty Ltd, Sydney (AU)

(72) Inventors: Abishek Sriramulu, Wyndham Vale (AU); Nicolas Fourrier, Auckland (NZ)

(21) Appl. No.: 18/824,730

(22) Filed: Sep. 4, 2024

Related U.S. Application Data
(60) Provisional application No. 63/644,235, filed on May 8, 2024.

(51) Int. Cl. G06Q 30/0201; G06N 7/01; G06N 20/00; G06Q 30/0202

(52) U.S. Cl. CPC G06Q 30/0206; G06N 7/01; G06N 20/00; G06Q 30/0202

(57) ABSTRACT

Methods for configuring learning model for price optimization. Item ontologies defining categories, properties, and relationships between multiple items, and sales data for items are used to aggregate sales data for subsets of the items and create sales vectors for the items, A price optimization target for items can be specified as a function of a price vector and the sales vector. A learning model is trained based on the price vectors and the sales vectors to optimize the price of each specific item in accordance with the price optimization target.

### RELATED APPLICATION DATA

This application claims priority to U.S. Provisional Application Ser. 63/644,235, titled “SYSTEM AND METHOD FOR PRICE OPTIMIZATION IN RETAIL USING GRAPH-BASED MACHINE LEARNING”, filed on May 8, 2024, the disclosure of which is hereby incorporated herein by reference in its entirety.

### FIELD OF INVENTION

The present disclosure relates to preparing training data for a machine learning model and to affect systems and methods for item price optimization using graph-based machine learning techniques.

### BACKGROUND

In commerce, e.g., retail operations, pricing strategies play a central role in determining the sales and profit of a product and thus the success of a business. For example, during markdowns and promotions, the ability to optimize prices can greatly influence sales volumes, revenue generation, and overall profitability. However, the complexities inherent in dynamic market environments often pose challenges to traditional methods of price optimization.

Historically, retailers have relied on relatively simplistic pricing strategies or manual adjustments based on intuition or mathematical models that estimate price elasticity in isolation to other demand influencing factors, such as school holidays, weather, promotions of other related products, availability and pricing of other related products, visibility on the shelf and the like. These approaches, while straightforward, often fail to capture the intricate relationships among variables influencing consumer behavior and sales dynamics. As a result, these methods often lead to suboptimal pricing decisions, resulting in missed revenue opportunities, excessive inventory write-offs, and eroded profitability.

In an attempt to address these challenges, various techniques have been developed. These include rule-based algorithms, statistical models, and heuristic approaches based on historical sales data. While these methods have provided some level of improvement over manual pricing, they often fall short in capturing the intricate relationships among variables influencing consumer behavior and sales dynamics. Furthermore, these solutions have struggled to adapt to evolving market conditions and changing consumer preferences in real-time.

When using conventional machine learning techniques for determining pricing strategies, the lack of long-term data regarding sales of certain products has resulted in training data that has a high signal-to-noise ratio. With respect to learning models, “signal” refers to data that is useful for determining patterns and “noise” refers to data that is erratic and/or otherwise not useful for predicting patterns of concern. Accordingly, trained machine learning models often overfit to the noise in the training data and thus do not perform well.

### SUMMARY

Implementations disclosed herein provide a more sophisticated and adaptive approach to price optimization, in retail situations for example. The disclosed implementations leverage advanced machine learning techniques and incorporate comprehensive data analysis to accurately forecast sales, identify relationships among items by analyzing sales patterns, identify underperforming products, optimize pricing strategies under various operational and business constraints, and dynamically adjust prices based on changing market dynamics. This empowers sellers to maximize revenue, minimize inventory write-offs, and enhance overall profitability in a competitive market, such as a retrial sales landscape.

Disclosed implementations provide a method for training a learning model to dynamically determine optimum sell prices for items, the method comprising: receiving an item ontology defining categories, properties, and relationships between multiple items; receiving sales data for items in the item ontology; aggregating sales data for subsets of the items based on the item ontology to sales vectors for the items; Identifying relationships among items by analyzing sales patterns; specifying a price optimization target for each specific or a group of items as a function of a price vector of the specific item and the sales vector corresponding to the specific item; training the learning model based on training data that includes the price vectors and the sales vectors to predict demand at multiple possible sell prices and, based on this prediction, select at least one sell price that satisfies the price optimization target.

Disclosed implementations also include systems and media for performing the method. According to other disclosed implementation, each item can be a family of products or services for which pricing decisions are related. For example, by default, and item can be defined as a SKU within a specific store. Each SKU in a store is considered a unique item. Therefore, the same SKU in a different store can be treated as a different item. However, this definition can be customized by the user to reflect any desired level of granularity. For example, a user can choose to define an item as a SKU across all stores or as a group of SKUs. Further, a price family can be an individual item.

Each price optimization target may include at least one of maximizing profits, maximizing sales in a specified time period, minimizing inventories and/or minimizing write-offs. The hierarchical data structures may include at least one of product category hierarchies, product characteristics, and/or geographical hierarchies.

### BRIEF DESCRIPTION OF FIGURES

Non-limiting and non-exhaustive examples are described with reference to the following figures.

FIG. 1A illustrates a product ontology graph

FIG. 1B illustrates a product ontology graph aggregated with sales data.

FIG. 2 s a flowchart of a method in accordance with disclosed implementations.

FIG. 3 is a computer architecture in accordance with disclosed implementations.

### DETAILED DESCRIPTION

The following description sets forth exemplary aspects of disclosed implementations. It should be recognized, however, that such description is not intended as a limitation on the scope of the present disclosure. Rather, the description also encompasses combinations and modifications to those exemplary aspects described herein.

The terms global model and foundational model are used interchangeably herein.

A pricing strategy refers to a plan and schedule for pricing. For example, on week 20 there will be a 10% discount that continues for 2 weeks and at week 30 there will be a 5% reduction in price permanently.

Traditional methods of price optimization often struggle to capture the complex relationships among variables influencing sales, leading to suboptimal pricing decisions and missed revenue opportunities. In particular, usual machine learning techniques for determining pricing strategies only use one hierarchical level. If they use a granular level (lower levels in the hierarchy—item/sku level) they would have low signal-to-noise ratio (low is bad) leading to bad predictions over fitting to noise. If they choose a high level in the hierarchy (category or regional level) they would have relatively clearer signals leading to high signal to noise ratio (high is good) but leads to over generalization where there is one pricing strategy for an entire category or region, which is suboptimal since each item's price change is perceived differently by consumers.

The low signal to noise ratio is not just because of lack of long-term data, even if there is long term data, everything at lower level is hierarchy has relatively poor/low signal to noise ratio.

Conventional pricing mechanisms are resource intensive because they require tremendous amounts of data to be useful. Also, conventional mechanisms require price exploration if a product has never seen a certain price point in the past (price exploration is the concept of trialing with a new price point to collect data on consumer response to this new price and using the data to train a learning model).

Disclosed implementations extract greater knowledge from existing data by turning data into a web of interconnected networks-allowing cross-learning (cross-learning is the concept where the learning model learns to one product by fine-tuning the knowledge learned from modelling other products).

To address these challenges, the present disclosure introduces a novel system and method that leverages advanced machine learning techniques and graph-based methodologies to provide a method for training a learning model that is capable of making predictions based on the complex relationships among variables influencing sales. The phrase “graph-based model” (also known as network based model) is any learning model that can incorporate information for related items and/or hierarchical aggregates while forecasting for a specific item. By integrating comprehensive data analysis, hierarchical graph construction, and feature-rich encoding, the disclosed implementations enhance sales forecasting accuracy and facilitate informed pricing decisions. This approach allows for the dynamic adjustment of prices based on real-time insights, thereby empowering sellers to maximize revenue, minimize inventory write-offs, and enhance overall profitability in a dynamic and competitive landscape.

Disclosed implementations utilize graph-based machine learning techniques. These techniques may be employed to uncover intricate relationships within retail data. By constructing hierarchical graphs based on domain knowledge and data-driven methods, the system may extract valuable insights from interconnected products.

Disclosed implementations can use a foundational model approach where a shared model is built across a large group of items, as opposed to creating separate models for each individual item. The “item” the level at which predictions/optimization is made. An item can be a SKU within a specific store. By default, each SKU in a store can be considered a unique item. Therefore, the same SKU in a different store can be treated as a different item. The item can be defined by the user to reflect any desired level of granularity. For example, a user can choose to define an item as an SKU across all stores or as a group of SKUs. These models may be designed to capture overarching patterns that are applicable across all the items in the shared model. They may utilize shared parameters and latent space projections to learn these general patterns. Despite modelling the generalized patterns across all items in the shared model, the model fine-tunes the generalized knowledge extracted from the group to every item in the group. During training, the model may operate sequentially in a univariate fashion, focusing on one item at a time. At test time, it may operate entirely in a univariate manner, meaning it considers only the data from the individual item being evaluated. This enables the model to learn across items to capture price elasticity behaviors across similar and/or related items.

Sales data for some products or product categories can be noisy and intermittent when examined at a granular level. Conventional models are trained on historical sequences of the target data to predict future values. Sometimes additional inputs known to affect the sales, called exogenous variables, may also be provided to the model. Disclosed implementations leverage a graph-based global model to incorporate information like seasonality and trends from higher, more aggregated levels of the product ontology/hierarchy. This allows the model to leverage more clear patterns from higher levels to improve forecasts at lower levels. This can be especially useful for making predictions on the sales of short life cycle products where there is insufficient data to adequately train a learning model. By accurately forecasting sales, identifying underperforming items, dynamically adjusting towards optimal price or pricing strategies based on real-time insights, the disclosed implementation empower sellers to maximize revenue, minimize inventory write-offs, and enhance overall profitability. The following equation illustrates this concept. The framework is flexible to handle different sequence lengths for Y, X and Z.

$${Y}_{t} = f ( {Y}_{t - 1} , {Y}_{t - 2} , … , {Y}_{t - n} , {X}_{t} , {X}_{t - 1} , … , {X}_{t - m} , {Z}_{t} , {Z}_{t - 1} , … , {Z}_{t - p} )$$

Where:
(Yₜ, Yₜ₊₁, . . . , Yₜ₊ₕ) is the sales sequence at time t.
(Yₜ₋₁, Yₜ₋₂, . . . , Yₜ₋ₙ) are historical values used for prediction.
(Xₜ, Xₜ₋₁, . . . , Xₜ₋ₘ) are exogenous variables including future information available at time t.
(Zₜ, Zₜ₋₁, . . . , Zₜ₋ₚ) represent context information from graphs and/or higher levels of the hierarchy, capturing clear seasonality and trends.
Where h is the forecast horizon, n is the look back for Y, m is the look back for X and p is the look back for Z.

Disclosed implementations can integrate domain knowledge based on hierarchical graphs, aggregate sales data, and extract relevant features for enhanced sales forecast accuracy. By incorporating conformal predictions and a graph-based forecasting model, the disclosed implementations can identify the optimum pricing strategies for products (based on forecasted sales), considering various demand influencing factors and business objectives.

Disclosed implementations use machine learning techniques to analyze the constructed graphs and extract valuable insights. For example, the system may identify clusters of items that tend to be purchased together or identify trends in the sales data that correlate with changes in the prices of related items. These insights may be used to inform pricing decisions, such as identifying opportunities for markdowns or promotions.

Disclosed implementations use the extracted features and insights to train a machine learning model. This model may be used to forecast sales, identify underperforming items, identify the optimal pricing strategy for underperforming items. The system may then use this identified optimal pricing strategy to dynamically adjust prices based on real-time insights, thereby empowering sellers to maximize revenue, minimize inventory write-offs, and enhance overall profitability.

The constructed graphs can be periodically or continuously updated and used to retrain the machine learning model as new sales data is received. This may allow the system to adapt to changing market conditions and consumer preferences, thereby further enhancing the accuracy of sales forecasting and the effectiveness of pricing decisions. This may involve adding new nodes to the graph to represent new items or updating the edges of the graph to reflect changes in the relationships among the items.

The hierarchical graphs may be used to capture information about the relationships among various items, such as their categorization or their properties. Hierarchical graphs include, for example: Product Hierarchies, Geographical Hierarchies and a combination thereof (Groceries across entire city) For example, items may be grouped together based on their category, such as clothing, electronics, or groceries. Within each category, items may be further grouped based on their properties, such as color, size, or brand. These groupings may form the higher level nodes of the hierarchical graph, with edges representing the relationships among the nodes. This aggregation of hierarchal data results in more continuous data with a better signal-to-noise ratio. Conventional methods, where forecasting is accomplished independently, tend to require bootstrap methods to reconcile the various levels of hierarchy. In the disclosed implementations, the consistency is inherent.

Hierarchical forecasting can also be performed to inform businesses on the demand at every hierarchical level for planning ahead. Since, in the disclosed implementations, consistency of hierarchical forecasts is inherent, there is no need for multiple optimization steps to reconcile them.

The construction of Causal graphs may be based on data-driven methods. These methods may involve analyzing the sales data to identify correlations or patterns among the items. For example, the system may identify items that tend to be purchased together, or items whose sales fluctuate in a similar manner over time. These correlations or patterns may be used to define the relationships among the items, which may be represented as edges in the causal graph. Machine learning techniques can be used to construct the causal graphs. These techniques may involve training a machine learning model on the sales data (and possibly related metadata and exogenous variables) to identify the relationships among the items. The model may be trained to recognize patterns or correlations and causations in the sales data, and to use these patterns or correlations to define the edges of the causal graph.

Disclosed implementations can use the extracted insights to train a separate machine learning model for forecasting sales. This model may be trained to predict future sales based on the current prices of the items and the extracted insights. The system may then use this model to identify underperforming items and determine optimum pricing strategies for the underperforming items, taking into account various demand influencing factors and business objectives. A user can add or remove items from the list of underperforming items, so the optimization will be for the modified list of items.

For example, if the system forecasts a decrease in sales for a particular item, it may recommend a markdown or promotion for that item to increase sales. Conversely, if the system forecasts an increase in sales for a particular item, it may recommend an increase in the price of that item to maximize revenue. This dynamic adjustment of prices may empower retailers to maximize revenue, minimize inventory write-offs, and enhance overall profitability. However, the user can also control price adjustments by specifying, for example, that a price should not be increased. Further a user can add any type of rule, such as a maximum number of items for which prices can be changed in one week.

Disclosed implementations can incorporate information like seasonality and trends from higher levels of the retail hierarchy to improve training data thus yielding an improved forecasting model. The clearer patterns from higher levels can be used to improve forecasts at lower levels. For instance, the system may aggregate sales data for subsets of items based on the item ontology to create sales vectors for the items. These sales vectors may capture overarching patterns in the sales data, such as seasonal trends or long-term sales growth. By incorporating these overarching patterns into the learning model, the system may enhance the accuracy of sales forecasting and facilitate more informed pricing decisions.

For example, the system may use a machine learning algorithm to analyze the aggregated sales data and identify patterns such as seasonality or trends. The system may then incorporate these patterns into the learning model as features, thereby enhancing the model's ability to forecast sales and identify optimum pricing strategies.

Disclosed implementations can aggregate sales data for subsets of items based on the item ontology to create sales vector data for the items. The item ontology may define categories, properties, stores, geographies, and relationships between multiple items. For instance, items may be grouped together based on their category, such as clothing, electronics, or groceries. Within each category, items may be further grouped based on their properties, such as color, size, or brand. These groupings may form the basis for aggregating sales data for subsets of items.

A price optimization target can be specified for each specific item or a group of items. This target may be specified as a function of a price vector of the specific item and the sales vector corresponding to the specific item. The price vector may represent the current and potential future prices of the item, while the sales vector represents the aggregated historical and forecasted sales of the item. The function used to specify the price optimization target may be selected based on the business objectives of the retailer. For example, the function may be designed to maximize profits, maximize sales in a specified time period, minimize inventories, and/or minimize write-offs.

The price optimization target can be updated as new sales data is received. This may involve recalculating the price optimization target based on the updated sales vector and the current price vector of the specific item. This continuous updating may allow the system to adapt to changing market conditions and consumer preferences, thereby further enhancing the effectiveness of pricing decisions.

Simple algorithms and/or machine learning techniques can be used to specify the price optimization target. For example, the system may use a machine learning algorithm to analyze the price vector and the sales vector of the specific item, and to specify the price optimization target based on this analysis. The machine learning algorithm may be trained to recognize patterns or correlations in the price vector and the sales vector, and to use these patterns or correlations to specify the price optimization target. Alternatively, a simple set of rules or equations can be used.

A ‘what-if’ simulation tool may also present adjusted pricing strategies based on the altered inputs. In the what-if tool, when price is adjusted, the output is forecasted sales. But when anything else is adjusted, the output is adjusted pricing strategies. Additionally the what-if tool can also run simulations to determine how different pricing rules or compliance conditions may impact the sales and profitability. adjusting the pricing rules and compliance conditions will output a new pricing strategy. Both the above what-if simulations can be done per item or groups or all of the items.

The simulation will also output the impact of adjustment of one item's setting on the others. For example changing prices of pasta may affect the sales of pasta sauce.

For example, the tool may identify the optimum pricing strategies for each item at the adjusted prices, taking into account various demand influencing factors and business objectives. These adjusted pricing strategies may provide users with valuable insights into the potential outcomes of different pricing decisions, thereby facilitating more informed decision-making.

The ‘what-if’ simulation tool may contrast the outcomes between the old and new strategies, aiding users in comprehending the overall impact. For instance, the tool may compare the sales forecasts and pricing strategies based on the current prices with those based on the adjusted prices. This comparison may provide users with a clear understanding of the potential impact of the adjusted pricing strategies on sales and profitability.

Disclosed implementations may include an anomaly detection feature. This feature may be based on the probabilistic forecast obtained from the machine learning model. The system may monitor the actual recorded sales and compare them with the lower and upper bound predictions from the probabilistic forecast. If the actual recorded sales fall outside these bounds continuously, the system may consider this an anomaly. In such cases, the system may alert the user to check for any process or data errors that might be causing the anomaly. This anomaly detection feature may provide an additional layer of oversight, helping to ensure the accuracy of the sales forecasts and the effectiveness of the pricing decisions.

The anomaly detection feature may be configured to trigger an alert when the actual recorded sales fall below the lower bound or above the upper bound of the probabilistic forecast for a specified number of consecutive time periods. The number of consecutive time periods may be user-defined, allowing the user to customize the sensitivity of the anomaly detection feature. This feature may provide users with timely alerts about potential issues, enabling them to take corrective action as soon as possible.

The anomaly detection feature may be integrated with other components of the system. For instance, the anomaly detection feature may interact with the machine learning model to adjust a forecast in response to detected anomalies. This may involve retraining the model on the updated sales data or adjusting the model parameters to better capture the observed sales patterns. This integration may allow the system to adapt to changing market conditions and consumer preferences, thereby further enhancing the accuracy of sales forecasting and the effectiveness of pricing decisions.

The anomaly detection feature may be used in conjunction with the ‘what-if’ simulation tools. For example, users may use the ‘what-if’ simulation tools to explore different scenarios and understand their potential impacts on sales and profitability. If an anomaly is detected, the user may use the ‘what-if’ simulation tools to simulate the impact of different corrective actions, such as adjusting prices or changing business rules. This feature may provide users with a flexible and interactive tool for managing anomalies and optimizing pricing decisions.

Implementation may involve fine-tuning model parameters, including but not limited to sampling strategies, number of lags, and other parameters, by conducting backtesting evaluations using historical data. This process may involve training the model on a portion of the historical data, and then testing the model's performance on the remaining data. The model parameters and sampling strategies may be adjusted based on the results of the backtesting evaluations to ensure robust performance and alignment with business objectives. This feature may provide users with a flexible and adaptive tool for optimizing their pricing strategies.

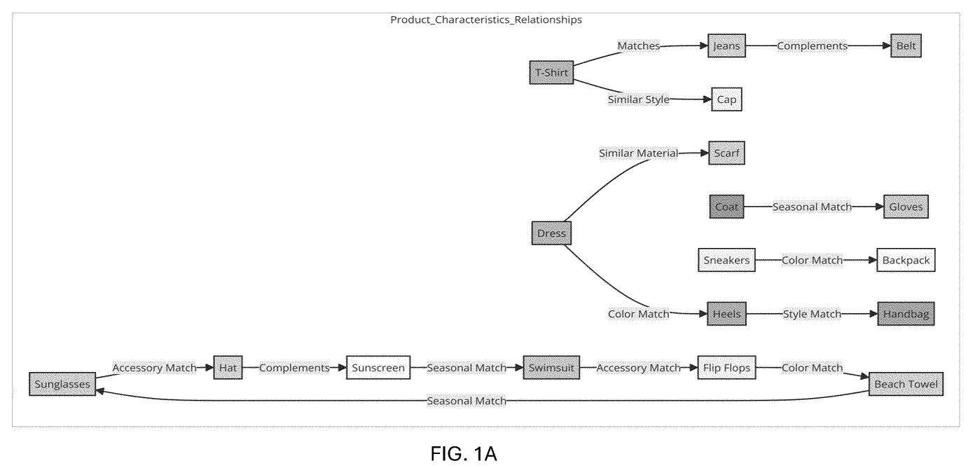

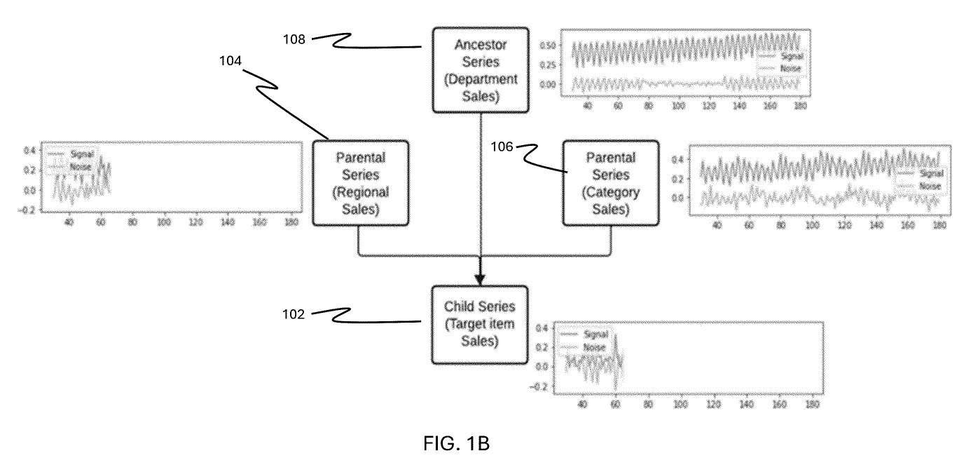

FIG. 1A illustrates an example of a causal graph. Products are associated in a web-like manner based on various relationships of such as halo effect, cannibalizing or substituting relationship, complementary relationships, style matches, and the like.

FIG. 1B illustrates a simple example of a product hierarchical connection to a specific item that is part of a graph in accordance with disclosed implementations. The example shown in FIG. 1B corresponds to a single item SKU123 (such as a flipflop) at Store123. SKU 123 is represented at node 102 of the graph. Note that regional sales can be aggregated for SKU123 across all stores in a region at node 104. Category sales can be aggregated for sales of all SKUs under the category flipflop at Store123 at node 106. Ancestor sales, at node 108, represent an aggregation of sales of all SKUs under footwear department at Store123. All of the data in nodes 102, 104, 106, and 108 can be used as training data for a machine learning model for price prediction. For example, when the product has a short product lifecycle (where a same item is not sold for more than, for example, 104 weeks due to its seasonal nature or rapid evolution), it is difficult to estimate seasonality and trend. However, disclosed implementations learn the seasonality and trend from higher levels in the hierarchy (even if SKU123 is not sold for more than 104 weeks, footwear as a group will be sold for more than 104 weeks). This knowledge pooled from all the connected hierarchical nodes (parents and ancestors) is passed to the target node 102 and helps and improves training of the learning model to make better predictions for the target node 102.

FIG. 1B also illustrates examples of signal and noise graphs for each node. Note the child series are often more erratic compared to higher levels in the hierarchy. A low signal to noise ratio makes prediction inaccurate. As we go higher in the hierarchy the signal to noise ratio improves, i.e. increases. Noise is erratic and thus is not good for training data, while signal is more predictable and improves training data. Since high quality signals are inherited from parent nodes and ancestor nodes the learning model is trained with more valuable information and thus can make predictions for the target node with higher accuracy.

The example of FIG. 1B shows only limited connections for the sake of brevity. However, in practice there could be multiple regional hierarchies, such as council level, state level, national level . . . . Also, product characteristics and categories could have more levels based on functionality (e.g., casual/trendy/formal), Color, material, and the like. This would result in more parental and ancestor series. Furthermore, each of the product category and characteristics based aggregations could also have regional aggregations (e.g., regional sales of all flipflops or footwear). The graph could also be reduced to just using more significant connections if there is need to reduce data complexity or use limited connections based on domain knowledge.

The graph of FIG. 1B is obtained by aggregating item sales data using the product hierarchies shown in FIG. 1A (e.g., category, sub-category, Style, product characteristics (e.g., color, functionality), and geographical hierarchies (e.g., store, region, state, national levels) resulting in aggregated sales data for each price-family. The aggregated information is referred to as “sales vectors” herein. Aggregations over hierarchical structures can be expressed as:

$$\begin{matrix}{S}_{k} = \sum {S}_{i} \\ i ∈ {I}_{k}\end{matrix}$$

where Sₖ is the aggregated sales for a particular hierarchy level k, and Sᵢ are individual sales data points, and Iₖ is the set of indices at hierarchy k.

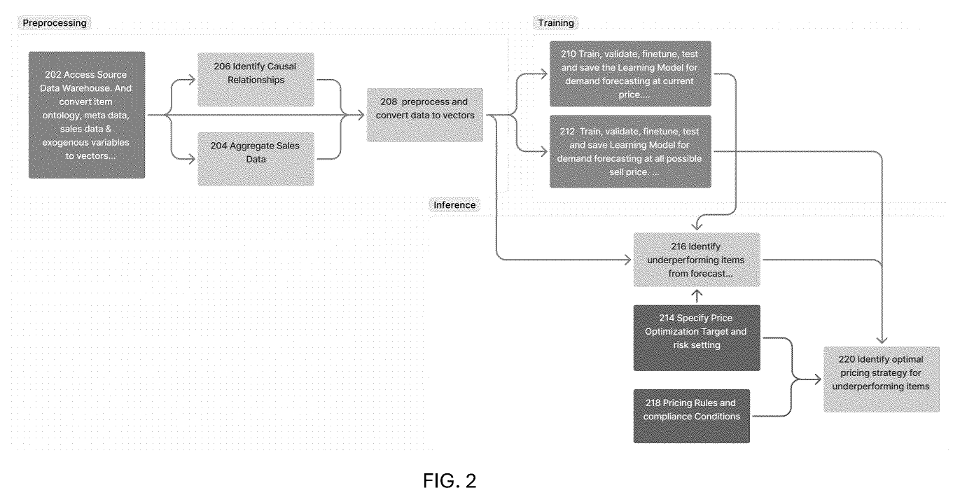

FIG. 2 illustrates a method for training a learning model to dynamically determine optimum sell prices for items in accordance with disclosed implementations. The method starts at step 202 by receiving access to source data warehouse which contains item ontology, meta data, sales data and exogenous variables which is all then converted to vectors. Other data that can be received includes sales history, pricing data, any promotion plans, meta data such as cost price, target audience (gender, age-group), peak period, off peak period, etc. At step 204, sales data from step 202 for subsets of the items is aggregated based on the item ontology. At step 206, all the data from step 202 are used to identify causal relationships among the items. At step 208, all the data from steps 202, 204 and 206 are preprocessed and converted to vectors. At step 210, a learning model is trained. At step 212, the learning model is validated, finetuned, tested and saved for forecasting demand at all possible sell-price of the items.

At step 214, a price optimization target and risk level setting are specified for each specific item or a group of items as a function of a price vector of the specific item and the sales vector corresponding to the specific item. At step 216, a list of underperforming items are identified based on the forecasts obtained from the model trained in step 210 and information from step 214. At step 218, the rules and compliance conditions for pricing of each item is specified. At step 220, based on inference from the forecasting model trained in step 212, an optimal pricing strategy for each underperforming item is identified considering the information from step 214 and fully complying to the rules and conditions specified in step 218. Further, a “price family” can be defined. The price family specifies the scope at which pricing decisions will be applied. For example, a business might decide set prices uniformly across all sizes of a specific product, thus forming a single price family. This grouping is not limited to product characteristics but also extends to geography where a business might aim for consistent pricing across its stores within a particular region, leading to the creation of a price family based on product-region level.

As noted above, the price optimization target can be a function of price vector (p) and sales vector (q), such as maximizing profits, minimizing write-offs, or achieving a combination of different targets (e.g., a weighted average of sales-momentum and profits). The price optimization targets can be different for each price-family and/or item.

As noted above, extracting or estimating time series features such as annual seasonality and trend becomes challenging unless the price-family has been actively selling for more than two years. Typically, markdowns are applied to products with short life cycles, which may not always possess more than two years of sales history. Therefore, it becomes crucial to extract time series features and other patterns using feature engineering and extraction techniques from the hierarchical aggregation. For example, extracting seasonality from a sub-category like “Men's sweatshirt” can provide insights into the general seasonality pattern for men's sweatshirts, which can then be utilized to enhance the accuracy of forecasting sales for any specific price-family of men's sweatshirt. This can either be done in isolation separately or inside the learning model itself. Furthermore, aggregated data has better signal-to-noise ratio and augmenting the training data with such information will improve the forecast accuracy.

As shown above, sales data for similar categorical variables are aggregated over a specific period of time which can be chosen by model parameter turning. The features or knowledge from aggregated data is extracted and used to represent the category instead of one-hot encoding. The feature or knowledge extraction method used may involve any techniques from simple mathematical formulas to sophisticated learning models. This can either be done in isolation separately or inside the learning model itself.

One or more graphs are constructed based on domain knowledge or data-driven methods to represent relationships and dependencies among data variables. For example, Graphs G(V,E) can be constructed where V represents Nodes (e.g., price-family) and E represents edges indicating relationships (correlations, causations, hierarchies):

$${{G}^{n}}_{i = 1} ( V , E ) = Graph ( {V}_{i} , {E}_{i} , {W}_{ij} )$$

Where, Wᵢⱼ are weights on edges representing the strength or type of relationship, derived from data-driven methods or domain knowledge. The information from the related nodes (immediate neighbors in graphs G) for each price-family can be extracted using any feature engineering or extraction methods either in isolation separately or inside the learning model. Input variables to the machine learning model may be normalized and the model output variable (e.g., sales) may be normalized using techniques such as differencing or window-based normalization or in relation to variables like stock on hand data to adapt to scale changes towards the end of product life cycles.

As noted above, the graph of FIG. 1B and FIG. 1A can be thought of as two graphs that can be combined into one. The first graph includes hierarchical data structures and the second includes causal relationships data. In the hierarchical graph, items (child) are connected to its parents (aggregated items) and ancestors (aggregated parents). There would be multiple classes of nodes (N classes if there are N levels of aggregation). And the edges connecting them will represent what type of hierarchy it is (product category, product characteristics or geographical). In the casual graph, nodes correspond to items and edges indicate relationships such as cross-selling (products that consumers frequently buy together), cannibalization (products that substitute each other). These relationships are identified from data based on correlation and causation analysis from, for example, Point-of-Sale (POS) data. Furthermore, analyses from additional data from product characteristics such as material/ingredients, functionality to identify substitutions and complementary products can be aggregated. The final graph can be a union of these two graphs (hierarchical data structures and sales behavior) where the nodes would be items and its aggregates connected based on hierarchies and causality.

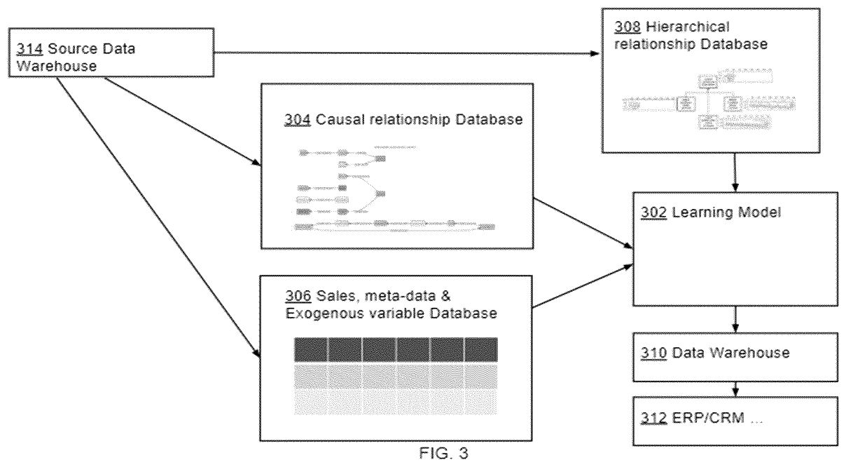

FIG. 3 illustrates a distributed computing system in accordance with disclosed implementations. Learning model 302, for example a decision-tree network or an artificial neural network, is trained, based on training data, to optimize price in the manner described above. causal relationship database 304 includes the above-noted graph based on causal relationships. Hierarchical relationship database 308 includes the above-noted hierarchical graph. Sales data, meta data and exogenous variables from source data warehouse 314 can be stored as vectors in database 306. The data from database 304, 306 and 308 are used as training data for learning model 302. Based on the above, it can be seen that the graph data includes domain knowledge with a high signal to noise ratio. Accordingly, learning model 302 can be trained to have much better performance as compared to conventional systems.

Each element in FIG. 3 can include computing hardware and software, which when executed by a processor, causes the hardware to accomplish the described functionality. For example, databases 304, 306, and 308 can include one or more database systems, such as relational database systems. Learning model 302 can be a decision-tree model, a random forest model, an artificial neural network or any machine learning model executing in a hardware environment.

Sale can be forecasted both as a point prediction and a probabilistic prediction for each product at current sell price within a price family level, taking into account all available demand-influencing factors using a graph-based foundational model. The forecast horizon can be defined as a user-defined. A target sell-out date of each price-family could be user-defined as target for optimization.

For each price-family, the default prediction can be considered to be the prediction from a probabilistic forecast corresponding to the 50th percentile. But risk preference can be varied between conservative, moderate and aggressive pricing strategies. For example, “conservative” can correspond to a higher quantile such as 75th percentile providing a more cautious estimate with a lower risk of underestimating demand; “Moderate” can be a default and can correspond to the median or 50th percentile, offering a balanced approach with equal weight given to both high and low demand scenarios; and “Aggressive” can correspond to a lower quantile, such as the 25th percentile, offering a more optimistic estimate with a higher risk of underestimating demand but potentially higher rewards if demand exceeds expectations. However, this should be used carefully since underestimating demand could result in lost opportunity to secure higher margin.

Based on the forecasts, underperforming price-families can be identified as the price-families that do not get sold-out or achieve some user-defined target. For price families that underperform, conformal forecasts as a point prediction and probabilistic prediction can be generated at all possible price points using a graph-based foundational forecasting model which is monotonically constrained to certain variables such as sell price, ensuring that sale forecast either remain constant or increase with decreasing prices.

A risk level for conformal forecasting for underperforming products can be set accordingly and price points that do not comply with business rules can be removed. For example, a seller may decide to never discount a specific item or price family by more than 30 percent off of suggested retail pricing.

Targets for each price family at each possible sell price can be calculated based on conformal predictions and the optimal price (p*) for each price family can be selected based on the calculated targets. For example if the objective is to maximize the target

$$\begin{matrix}\begin{matrix}{p}^{*} arg & max & {targets}_{p}\end{matrix} \\ p ∈ validPrices\end{matrix}$$

Products requiring a price change can be ranked based on the impact of the target estimate's difference between the current and optimal sell prices. Based on business rules, products can be selected for pricing adjustments during the current markdown period. Sales prediction and price change data can be stored in data warehouse 310 (FIG. 3). The price changes can be transmitted to Enterprise Resource Management/Customer Relationship Management (ERP/CRM) systems 312 (FIG. 3), and other systems, such as accounting systems for changing the prices.

Model parameters can be fine-tuned using methods including, but not limited to, sampling strategies, number of lags, and the like by conducting back testing evaluations using historical data. Model parameters and sampling strategies can be optimized to ensure robust performance and alignment with business objectives. The back testing setting is also strategically designed to align with business objectives.

Disclosed implementations can predict both demand and/or sales. The term “demand”, as used herein, can refer to sales. For example, demand could be a sales forecast even when there is no stock to sell.

A number of implementations have been described. Nevertheless, it will be understood that various modifications may be made without departing from the spirit and scope of the invention as defined by the following claims.

1. A method for training a learning model to dynamically determine sell prices for items, the method comprising:
receiving an item ontology defining categories, properties, and relationships between multiple items;
receiving sales, meta data and exogenous variables;
aggregating sales data for subsets of the items based on the item ontology to create hierarchical sales vectors for the items;
converting the sales data, the meta data and the exogenous variables to vectors;
training the learning model based on data that includes the price vectors and the sales vectors to predict demand at multiple possible sell prices and, based on this prediction, select at least one pricing strategy.

2. The method of claim 1, wherein each item is a family of products or services for which pricing decisions are related.

3. The method of claim 2, wherein each price optimization target includes at least one of maximizing profits, maximizing sales in a specified time period, minimizing inventories and/or minimizing write-offs.

4. The method of claim 1, wherein the aggregating step comprises aggregating sales data over hierarchical data structures are expressed as:
$$\begin{matrix}{S}_{k} = \sum {S}_{i} \\ i ∈ {I}_{k}\end{matrix}$$
where Sₖ is the aggregated sales for a particular hierarchy level k, and sᵢ are individual sales data points, and Iₖ is the set of indices at hierarchy k.

5. The method of claim 4, wherein the hierarchical data structures include at least one of product category hierarchies, product characteristics, and/or geographical hierarchies.

6. The method of claim 5, wherein the data structures comprise Graphs G(V,E) where V represents Nodes corresponding to the items and E represents edges indicating relationships (correlations, causations, hierarchies):
$$G ( V , E ) = {{U}^{n}}_{i = 1} Graph ( {V}_{i} , {E}_{i} , {W}_{ij} )$$
where, Wᵢⱼ are weights on edges representing the strength or type of relationship.7. The method of claim 1, wherein the training data includes at least one of local event data, holiday data, competitor pricing data, and/or weather data.

7. The method of claim 1, wherein the learning model is a graph-based foundational model which operates sequentially in a univariate fashion during training, focusing on one series at a time, and operates entirely in a univariate manner during inference, considering data from the individual series being evaluated.

8. The method of claim 7, wherein the graph-based foundational model incorporates information like seasonality and trends from higher, more aggregated levels of the retail hierarchy to improve granular-level forecasts.

9. The method of claim 1, further comprising performing a what if simulation to simulate new scenarios by adjusting any demand influential variable. The simulation also determines the impact of adjustment of one item's price on the other items.

10. The method of claim 1, further comprising specifying a risk level for each item that is used to select the pricing strategy for the items.

11. The method of claim 10, wherein selecting a price strategy comprises:
defining a set of pricing strategies based on varying levels of risk preference, wherein each pricing strategy corresponds to a specific quantile of the probabilistic forecast;
specifying one of the following pricing strategies:
a conservative pricing strategy specifying a relatively high quantile to provide a cautious estimate with a reduced risk of underestimating demand;
an aggressive pricing strategy by selecting a relatively low quantile with a reduced risk of overestimating demand;
a moderate pricing strategy corresponding to the median offering a balanced approach with equal consideration for overestimating and underestimating demand.

12. The method of claim 1, further comprising identifying underperforming price families and wherein the at least one pricing strategy is selected for the underperforming price families.

13. The method of claim 1, further comprising specifying a price optimization target for each specific item or a group of items as a function of a price vector of the specific item and the sales vector corresponding to the specific item or group of items.

14. A computing system for dynamically determining sell prices for items, the method comprising:
an item ontology database defining categories, properties, and relationships between multiple items;
a sales, meta-data and exogenous variables database storing all related data for items and other segments such as geographical and customer segments;
a sales vector database storing aggregated sales data for subsets of the items based on the item ontology to thereby create hierarchical sales vectors for the items;
a learning model trained based on data that includes price vectors and the sales vectors to thereby predict demand at multiple possible sell prices and, based on this prediction, select at least one pricing strategy.

15. The system of claim 14, wherein each item is a family of products or services for which pricing decisions are related.

16. The system of claim 15, wherein the price optimization target includes at least one of maximizing profits, maximizing sales in a specified time period, minimizing inventories and/or minimizing write-offs.

17. The system of claim 14, wherein the aggregated sales data is aggregated over hierarchical data structures are expressed as:
$$\begin{matrix}{S}_{k} = \sum {S}_{i} \\ i ∈ {I}_{k}\end{matrix}$$
where Sₖ is the aggregated sales for a particular hierarchy level k, and sᵢ are individual sales data points, and Iₖ is the set of indices at hierarchy k.

18. The system of claim 17, wherein the hierarchical data structures include at least one of product category hierarchies, product characteristics, and/or geographical hierarchies.

19. The system of claim 18, wherein the graph data structures comprise Graphs G(V,E) where V represents Nodes corresponding to the items and E represents edges indicating relationships (correlations, causations, hierarchies):
$$G ( V , E ) = {{U}^{n}}_{i = 1} Graph ( {V}_{i} , {E}_{i} , {W}_{ij} )$$
where, Wᵢⱼ are weights on edges representing the strength or type of relationship.

20. The system of claim 14, wherein the training data includes at least one of local event data, holiday data, competitor pricing data, and/or weather data.

21. The system of claim 14, wherein the learning model is a graph-based foundational model which operates sequentially in a univariate fashion during training, focusing on one series at a time, and operates entirely in a univariate manner during testing, considering data from the individual series being evaluated.

22. The system of claim 20, wherein the graph-based foundational model incorporates information like seasonality and trends from higher, more aggregated levels of the retail hierarchy to improve granular-level forecasts.

23. A method for representing categorical data in machine learning models, comprising:
extracting features from aggregated data associated with a category, wherein the feature extraction is performed at least one of, a) independently, prior to being input into the learning model, or b) integratively, within the learning model itself;
utilizing the extracted features in the machine learning model to represent the category.
